(19) United States
(12) Patent Application Publication
(10) Pub. No.: US 2023/0194790 A1
(43) Pub. Date: Jun. 22, 2023

(54) SILICON BEAM-STEERING APPARATUS AND METHOD FOR MANUFACTURING

(71) Applicant: Auroratech Company, Burlingame, CA (US)

(72) Inventors: Ziqi Peng, Burlingame, CA (US); Mark Flowers, Los Gatos, CA (US); Bayley Wang, Burlingame, CA (US)

(73) Assignee: AURORATECH COMPANY, Burlingame, CA (US)

(21) Appl. No.: 18/084,495

(22) Filed: Dec. 19, 2022

Related U.S. Application Data
(60) Provisional application No. 63/291,451, filed on Dec. 19, 2021.

(51) Int. Cl. G02B 6/35; G02B 6/136

(52) U.S. Cl. CPC G02B 6/3516; G02B 6/3518; G02B 6/352; G02B 6/136; G02B 2006/12085

(57) ABSTRACT

An optical silicon beam-steering apparatus made from one or more silicon wafers. The apparatus includes a bonded stack of one or more wafers including a mirror wafer and a possibly distinct wafer for actuation which allows the device to achieve a large scan range, a large mirror size and a high scan frequency.

### BACKGROUND

Mechanisms for optical beam-steering are useful in a variety of applications, for example, in laser ranging (LIDAR) devices, augmented reality headsets (ARHS), confocal microscopes, and micromachining systems. In these applications, it is desirable to have a large figure of merit (defined as the diameter of the mirror perpendicular to the scan axis times the scan angle); in LIDAR devices this determines the field of view and range of the sensor, in ARHS it determines the field of view and resolution, and in confocal microscopes and laser micromachining systems it determines the throughput. Another metric which affects performance is the repetition rate of the device over the full scan range. In ARHS and LIDAR this determines the frame rate of the system, which needs to be over a predetermined target in order to meet system goals. In other applications, this directly affects system throughput. Additionally, point-to-point control (“quasistatic”) of the beam angle is desirable or necessary for many applications.

Current beam-steering applications which need a large figure of merit and point-to-point control typically use a galvanometer, which is assembled from discrete magnets, coils, and mirrors. While these devices can perform well, their large size and high cost of manufacturing precludes their use in a wide variety of systems, for example, ARHS and high-volume LIDAR devices for Internet of Things (IoT) and autonomous driving.

Silicon micromachining is a technique which leverages photolithography and etching steps originally developed for the integrated circuit industry in order to fabricate hinges, actuators, gears, and other mechanical structures. By leveraging wafer-scale fabrication processes and existing equipment, thousands of parts can be simultaneously and cost effectively made on a single wafer, resulting in high volume capability and low per unit costs.

Silicon micromachining is also known as MEMS (micro electro-mechanical systems) since one of the major applications is the miniaturization of much larger electro-mechanical systems. Silicon micromachined optical beam-steering devices are also known as “MEMS mirrors” since in practice these devices take the shape of a silicon mirror suspended on one or more silicon hinges, actuated by an electrostatic, electromagnetic, electrothermal, or piezoelectric mechanism. Out of these mechanisms, electrostatic actuation offers cost and assembly advantages because it allows for monolithic or near monolithic fabrication using materials commonly found in the integrated circuit industry (monocrystalline Si, poly-Si, SiN, SiC, SiO2, among others). Piezoelectric actuation requires sophisticated structures to amplify the travel of the piezoelectric elements and is difficult to use for quasistatic devices. Electromagnetic actuation has a large size requirement, and high-power consumption. Electrothermal actuation is too slow for most dynamic systems.

It is well-known that existing techniques to fabricate electrostatically actuated micromirrors suffer from certain performance and geometry limitations which prevent them from achieving a high figure of merit. Improvements on the performance and geometry of these devices would enable low cost manufacturable, and reliable electrostatic MEMS mirrors to achieve higher figures of merit and meet the needs of more demanding applications.

### SUMMARY

The present disclosure is related to optical beam-steering apparatus, more specifically, silicon beam-steering apparatus made from one or more silicon wafers. The apparatus comprises a bonded stack of one or more wafers including a mirror wafer and a possibly distinct wafer for actuation which allows the device to achieve a large scan range, a large mirror size and a high scan frequency. A method for fabricating such an apparatus is also included in the disclosure.

### BRIEF DESCRIPTION OF THE DRAWINGS

FIG. 1 depicts a scanning mirror and its descriptive parameters.

FIG. 2 depicts a mirror suspended by flexure hinges.

FIG. 3 depicts the resonant modes of a mirror suspended by flexure hinges.

FIG. 4 depicts a magnetically actuated mirror.

FIG. 5 depicts another magnetically actuated mirror.

FIG. 6 depicts a basic electrostatic actuator.

FIG. 7 depicts Paschen's law.

FIG. 8 depicts a mirror actuated by electrostatic comb drives.

FIG. 9 depicts the geometry of an electrostatic comb drive at rest.

FIG. 10 depicts the geometry of an electrostatic comb drive at full travel.

FIG. 11 depicts two ways to offset comb drives.

FIG. 12 depicts a electrostatic actuator that does not use combs.

FIG. 13 depicts the anisotropic etching action of a base on silicon wafers.

FIG. 14 depicts a multi-wafer assembly which can be used to fabricate a type of actuator.

FIG. 15 depicts a process flow for manufacturing the assembly of FIG. 14.

FIG. 16 depicts the moving element of a beam steering device with a honeycomb structure.

FIG. 17 depicts the fabrication of a thin honeycomb element using an SOI wafer.

FIG. 18 depicts bump stops used to prevent over travel of the moving element.

FIG. 19 depicts a method to manufacture bump stops.

FIG. 20 depicts a torsion bar.

FIG. 21 depicts a serpentine hinge.

FIG. 22 depicts a rotated serpentine hinge.

FIG. 23 depicts a multiple bar rotated serpentine hinge.

FIG. 24 depicts a symmetric serpentine hinge.

FIG. 25 depicts a coaxial serpentine hinge.

FIG. 26 depicts a multi-electrode actuator.

FIG. 27 depicts one embodiment of a multi-electrode actuator.

FIG. 28 depicts a method of manufacturing a multi-electrode actuator.

FIG. 29 depicts a special trajectory for the moving element of a beam steering device.

FIG. 30 depicts a special arrangement of electrodes for an electrostatic actuator.

### DETAILED DESCRIPTION OF EXEMPLARY EMBODIMENTS

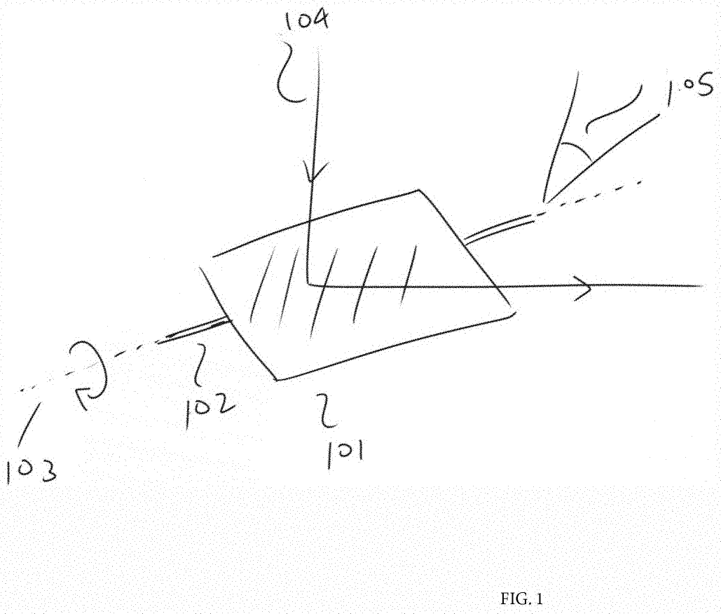

FIG. 1 depicts a scanning mirror, which is a reflective mirror 101 suspended by hinges or bearings 102 and rotating about a scan axis 103. Incoming light 104 is reflected by the mirror as it rotates through the mechanical scan range 105. The optical deflection range is then twice the mechanical scan range.

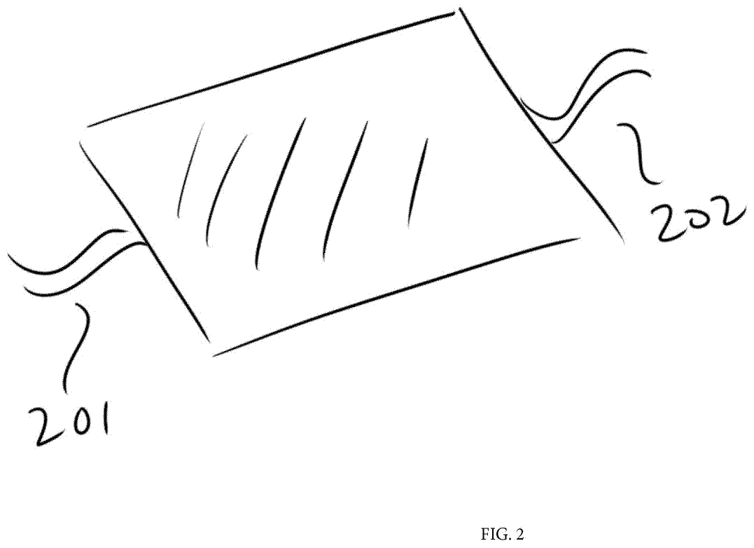

In some embodiments of a scanning mirror (FIG. 2), the mirror is suspended on flexure hinges 201, 202, which are made of an elastic material that allows for a large, but limited amount of rotation. Using flexure hinges allows for the mirror and its suspension to be fabricated from a single piece of material and removes the need for bearings and lubricants.

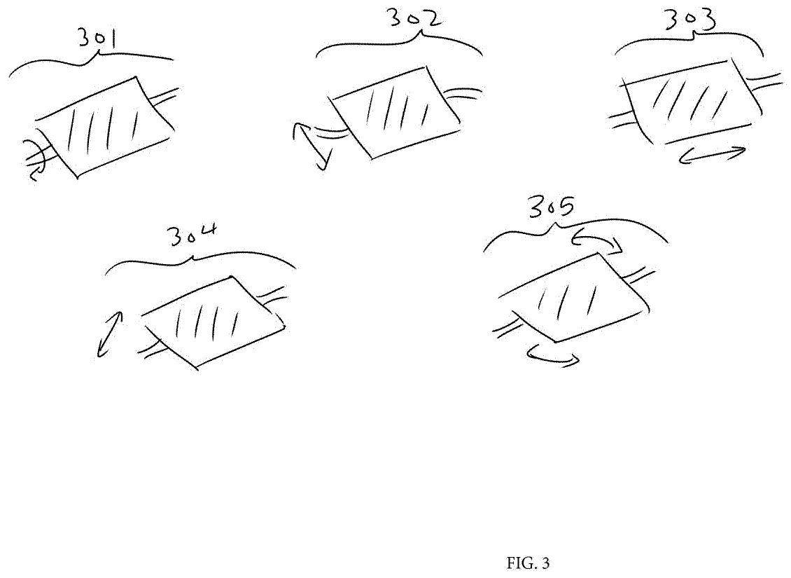

Because flexure hinges are elastic, the mirror-hinge system has several resonant modes, depicted in FIG. 3. The primary torsional mode 301 is the first resonant mode; there are several other modes 302-305 which must be suppressed. In order to achieve good point-to-point control of the mirror angle it is necessary for the primary mode to be at a higher frequency than the scanning frequency. The higher order modes must have a higher frequency than the scanning frequency (in order to not be excited by the drive signal) and any external stimuli the mirror may encounter.

A scanning mirror also requires one or more sources of force or torque in order to actuate the scanning. The main sources of actuation found in scanning mirrors are electromagnetic actuators, electrostatic actuators, electrothermal actuators, and piezoelectric actuators.

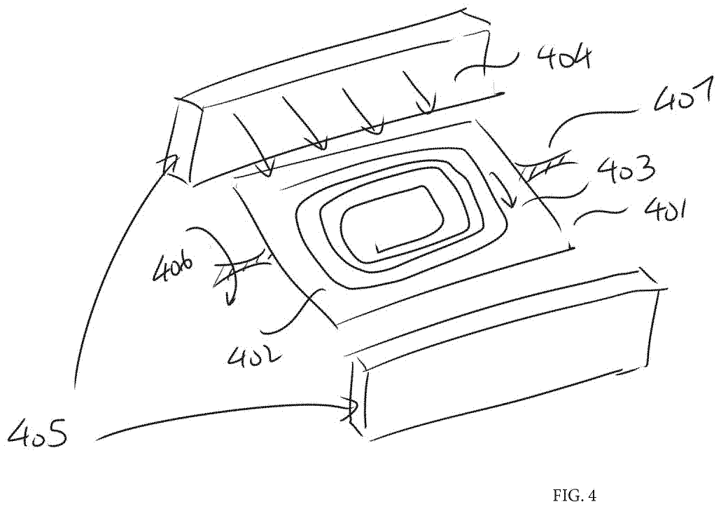

FIG. 4. depicts an electromagnetically actuated mirror. A electromagnetic coil 402 is attached to the mirror 401. In some embodiments, 402 is a discrete coil of fine wire which is glued or otherwise bonded to the mirror. In other embodiments 402 is a planar coil which is printed or deposited onto the non-reflective side of the mirror. A current 403 flows through the coil and interacts with a static magnetic field 404 produced by stationary permanent magnets 405 to generate a torque 406. This torque is proportional to the current flowing through the coil. In some embodiments the mirror is suspended on flexure hinges 407 which require a torque proportional to the deflection angle, so that the deflection angle of the mirror is proportional to the drive current. In other embodiments there are no flexure hinges, and closed loop feedback controls are used to determine the angle of the mirror.

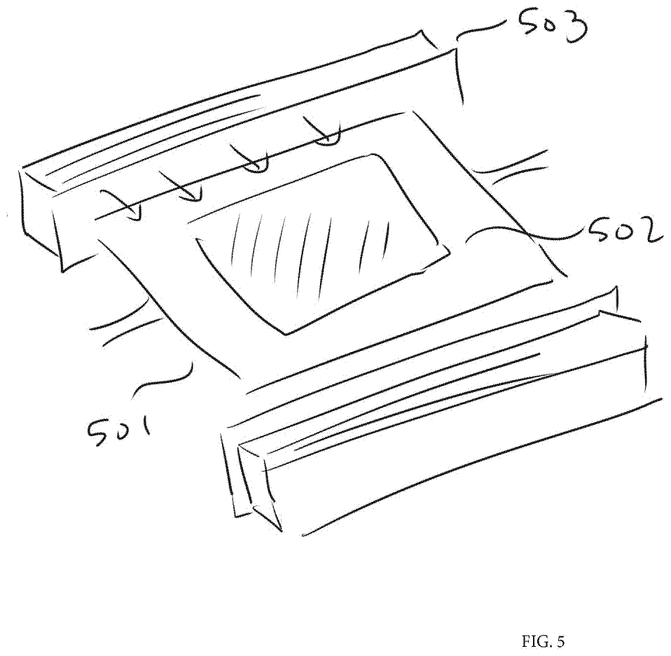

FIG. 5. depicts another electromagnetically actuated mirror. A permanent magnet 502 is attached to the mirror 501. In some embodiments, 502 is a discrete permanent magnet which is glued onto the mirror. In other embodiments, 502 is a layer of ferromagnetic material which is deposited onto the mirror. A stationary coil 503 generates a changing stationary magnetic field which interacts with the constant field created by 502 to generate a torque on the mirror.

The electromagnetically actuated mirrors in FIG. 4 and FIG. 5 have several disadvantages. Firstly, they require permanent magnets, which are not easily available in processes derived from integrated circuit manufacturing. The embodiment in FIG. 4 requires a costly assembly step to package the permanent magnets and align them with the mirror. The embodiment in FIG. 5 requires the deposition of a thick ferromagnetic film (which is not commonly found in semiconductor processes) or the attachment of a discrete permanent magnet (which incurs costly assembly and alignment steps). The moving coil in FIG. 4 is bonded to the mirror and conducts heat from resistive losses to the mirror, which induces thermal distortions that could introduce a difficult to control wavefront error into the optical system. Further, the moving coil in FIG. 4 requires electrical connections through the flexing hinges which can lead to fabrication complexity, cost and reliability issues.

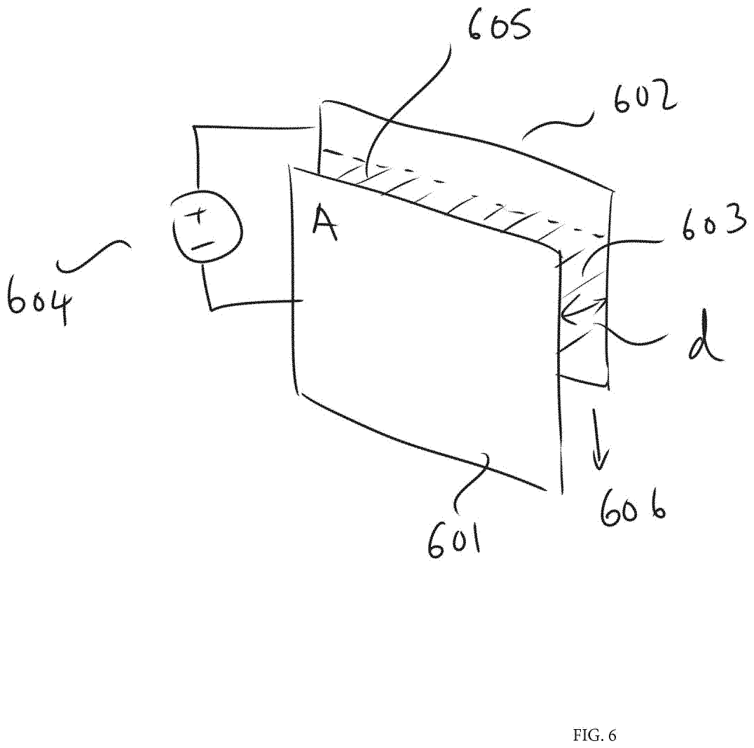

Therefore, it is desirable to avoid the use of electromagnetic forces for actuating the mirror. It is possible to use electrostatic forces in a way similar to electromagnetic forces. FIG. 6 depicts the basic arrangement of an electrostatic actuator. Two plates 601 and 602 with surface area A are separated by a small air gap 603 with thickness d. A voltage 604 of magnitude V is applied between the plates, which creates a parallel plate capacitor. The capacitance of this capacitor is proportional to the overlap area 605 between the two plates and inversely proportional to the gap between them. If plates 601 and 602 are not aligned with each other a motion of the plates to increase the overlap will increase the capacitance and therefore the stored energy; hence, applying a voltage to the plates will cause a force 606 in the direction tending to increase the stored energy, with magnitude equal to the derivative of the stored energy.

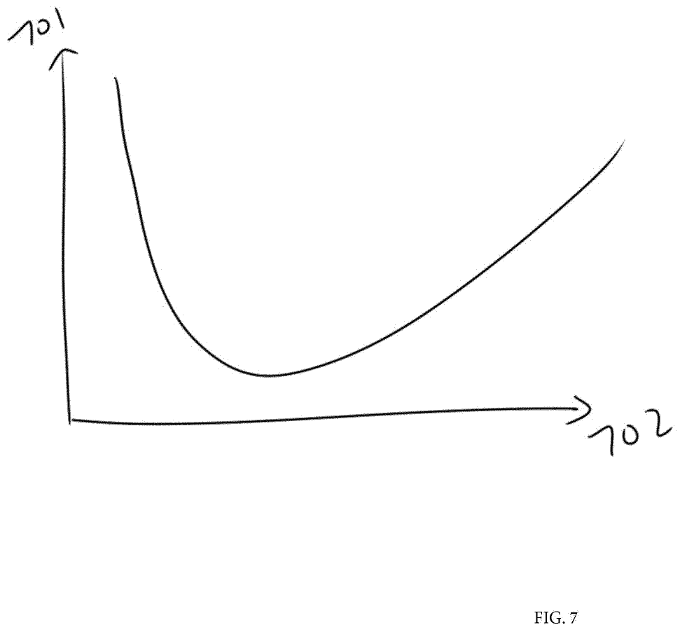

In practice the magnitude of the force which can be achieved is determined by the area A of the plates, the spacing d between them, and the maximum applied voltage V. The maximum voltage limit is in practice determined by the dielectric breakdown of the material in the gap (usually, air). FIG. 7 depicts “Paschen's Law”, which states that the maximum electric field 701 in volts per meter sustained by an air gap increases as the thickness of the gap 702 decreases. Hence the specific force generated by such an actuator increases as the actuator size decreases, which is why electrostatic actuation is favorable for small systems.

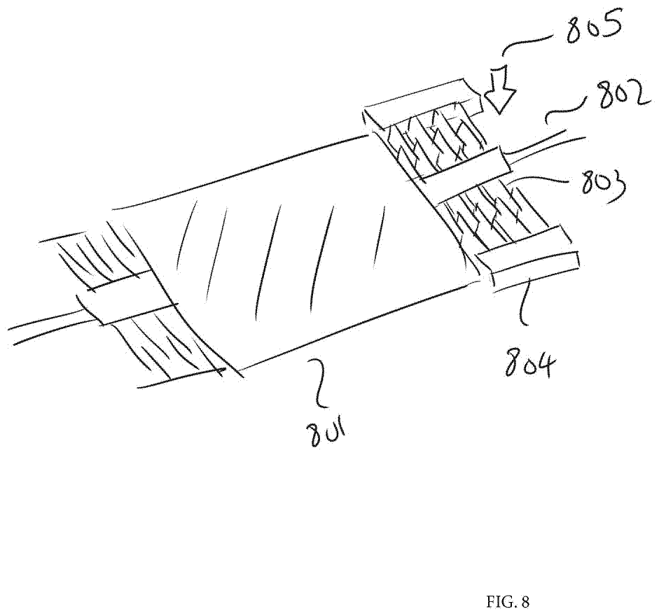

FIG. 8 depicts a practical realization of this concept. The mirror 801 is suspended on flexure hinges 802. Attached to the mirror are an assembly of combs 803 (the ‘rotor combs’) which are interleaved with sets of stationary combs 804 (the ‘stator combs’). Applying a voltage difference between the rotor combs and the stator combs causes a force 805 on the rotor combs in the direction that increases overlap (stored energy) if the stored energy is not already at a maximum.

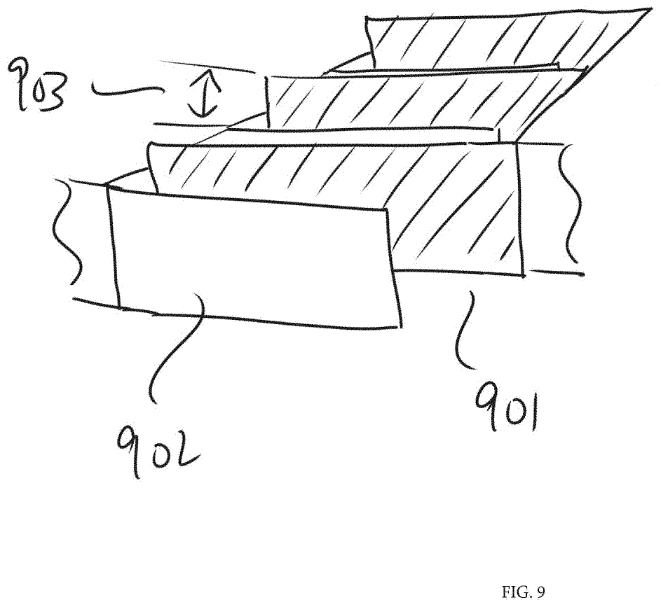

FIG. 9 depicts a detailed view of an electrostatic comb actuator in a resting position. The rotor combs 901 and stator combs 902 are offset at rest by a gap 903 so that a downward (upward) motion of the rotor combs increases the stored energy in the actuator structure.

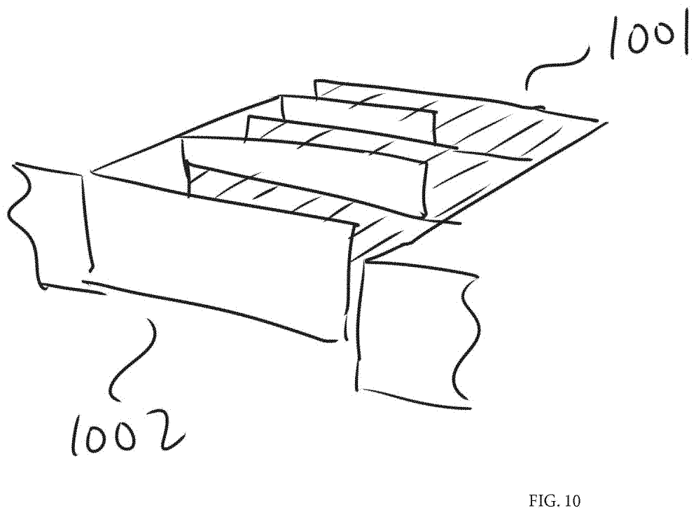

FIG. 10 depicts a detailed view of an electrostatic comb actuator at the limit of travel. The rotor combs 1001 and stator combs 1002 are overlapped completely, so that any motion serves to reduce the amount of energy stored in the structure. Therefore, the force output in this position is zero.

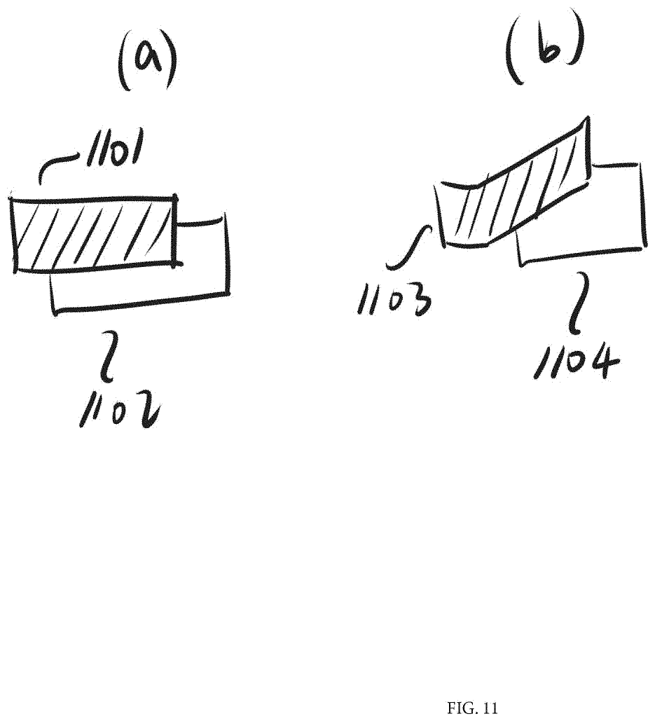

In practice, the force that can be produced by an electrostatic comb actuator vanishes to zero near the limit of travel. The force required to deflect the flexure hinges increases with the amount of travel, so the interaction between these two quantities sets an equilibrium position which determines the maximum achievable deflection of the hinges and therefore, the mirror. The cross-sectional area of each comb, the number of combs, and the initial offset between the combs determine the relation between output force and deflection angle. FIG. 11 depicts two ways to set the initial offset. In 11 (a), the rotor combs 1101 and stator combs 1102 are vertically offset (for example, but not limited to, wafer bonding or self-assembly). In 11 (b), the rotor combs 1103 are angularly offset from the stator combs 1104, through typically, but not limited to, a self-assembly process.

The maximum angular deflection for the micromirror in FIG. 8 is related to the linear excursion of the tip of the mirror 801. The depth of the rotor combs and stator combs 802 and 803 is related to the size of this linear excursion, which is equal to the product of the half-width of the mirror and the scan angle in radians. As this parameter increases, the magnitude of this excursion also increases, which requires a greater comb height. In practice, the combs are manufactured through a deep reactive ion etching process (D-RIE) through a monocrystalline silicon wafer; the height of the combs and the spacing between them determines the aspect ratio of the etch. It is desirable to have tall combs with a low spacing, since tall combs increase both the magnitude of the force and the linear excursion over which it is applicable, and the spacing between the combs is inversely proportional to the force developed at a given voltage. However, high aspect ratio etches can pose manufacturing challenges, with the largest aspect ratio applicable in high volume production being around 20:1. This poses constraints on both the maximum achievable excursion and the maximum achievable force. It is possible to increase the force by increasing the number of combs, but this poses issues with device yield since the failure of a single comb will destroy the entire device.

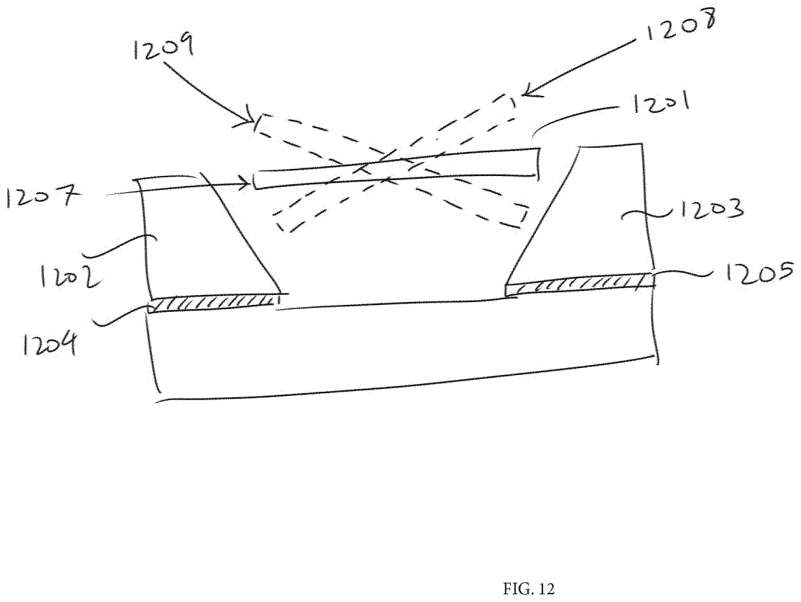

FIG. 12 depicts a type of electrostatic actuator that does not use combs. The mirror 1201 sits inside a trench with slanted side-walls 1202 and 1203. Side-walls 1202 and 1203 sit on a substrate 1204 and are electrically isolated from each other by two insulating layers 1205 and 1206. In order to actuate a clockwise motion from rest position 1207 to deflected position 1208, the mirror and side-wall 1202 are energized to different voltage potentials, which generates an electrostatic force between them. Since the spacing between the mirror and the side-wall decreases as the mirror moves from 1207 to 1208, the direction of the force tends to move the mirror in that direction. Likewise, to actuate a counter-clockwise motion from rest position 1207 to deflected position 1209, the mirror and side-wall 1203 are actuated to different voltage potentials.

Such an actuator presents several advantages. It does not require the fabrication of hundreds of combs, which increases device yields and reduces device cost. It is also capable of generating substantial force over a very large linear excursion, limited only by the depth of the trench structure. Such a capability enables the capability to have very large (over 2.5 mm in the direction perpendicular to the scanning axis) mirrors which have a large (over 30 degrees mechanical) scanning range.

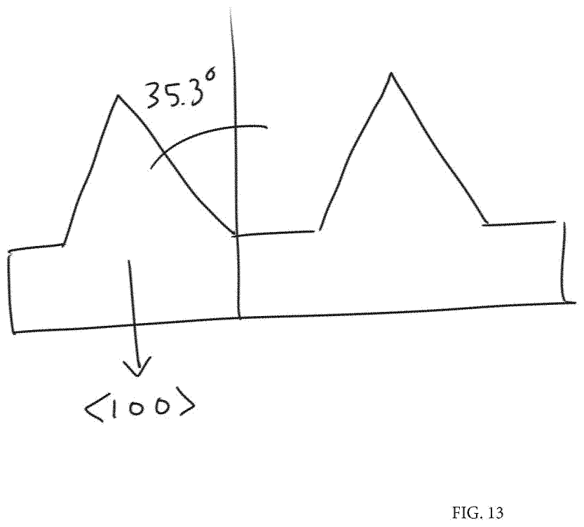

Fabrication of the slanted side-walls 1202 and 1203 can be done using an anisotropic wet-etching process. Hydroxides such as TMAH and KOH preferentially attack monocrystalline silicon in the <100> crystalline plane, so that etching a <100> silicon wafer with TMAH or KOH results in vertical side-walls with an approximately 35.3 degree angle to the normal, as depicted in FIG. 13.

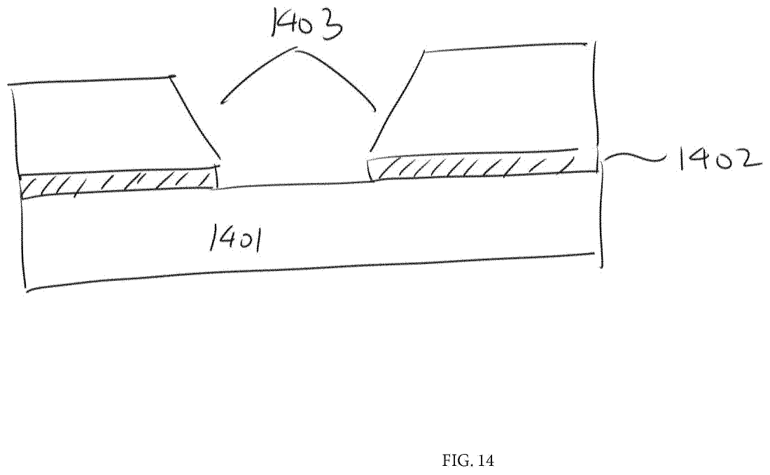

FIG. 14 depicts the cross-section of a multi-wafer assembly which can be used to fabricate an electrostatic actuator of the type depicted in FIG. 12. The base wafer 1401 has an insulating dielectric layer 1402 grown on it (for example, but not limited to, silicon nitride or silicon oxide). The electrode wafer 1403 is wafer-scale bonded to the base wafer using a Si-to-SiO2 bonding process.

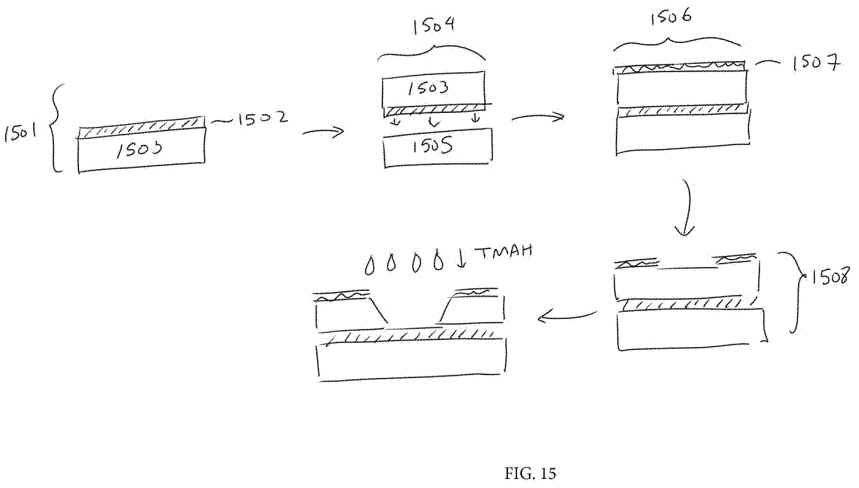

FIG. 15 depicts the details of an exemplary process flow which can be used to fabricate the assembly in FIG. 14. In step 1501, an oxide layer 1502 is grown on the electrode wafer 1503 using, for example but not limited to, thermal oxide growth. In step 1504, the electrode wafer 1503 consisting of the wafer and oxide layer is bonded to the base wafer 1505 using a Si-to-SiO2 bonding process. In step 1506, a layer of silicon nitride (1507) is deposited on the electrode wafer. In step 1508, photolithography is used to create a pattern on the silicon nitride layer. In step 1509, a wet anisotropic etch, for example, but not limited to, TMAH or KOH, is used to open trenches with slanted side-walls in the electrode wafer.

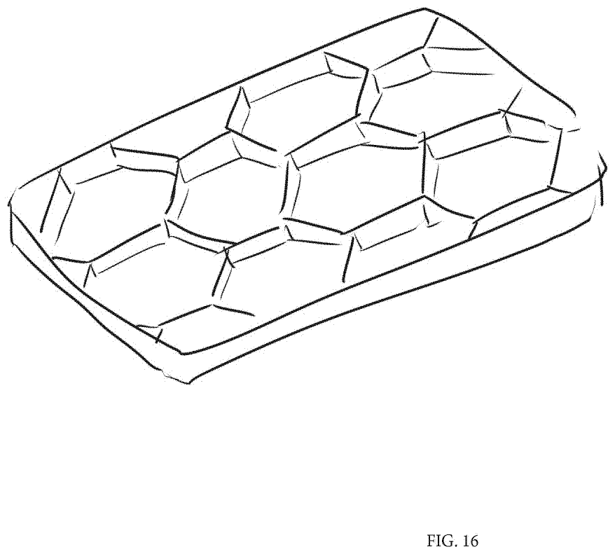

A limitation of very large beam-steering devices is the first mode resonant frequency of the mirror-spring system. In order to have high control bandwidth (in a closed loop system) and/or good linearity (in an open loop system) it is desirable to place the resonant frequency of the first mode several times higher than the operating frequency of the device. The resonant frequency is proportional to the square root of the spring constant of the hinges and inversely proportional to the square root of the mass of the moving element. In MEMS devices with larger mirrors, it is desirable to reduce the mass of the mirror in order to increase the first mode resonant frequency which will then increase the usable operating frequency without increasing the spring constant. One method to reduce mirror mass without excessively reducing its stiffness, is to create a honeycomb structure as in FIG. 16. It is also desirable to have the moving element be as thin as possible, with a uniform thickness.

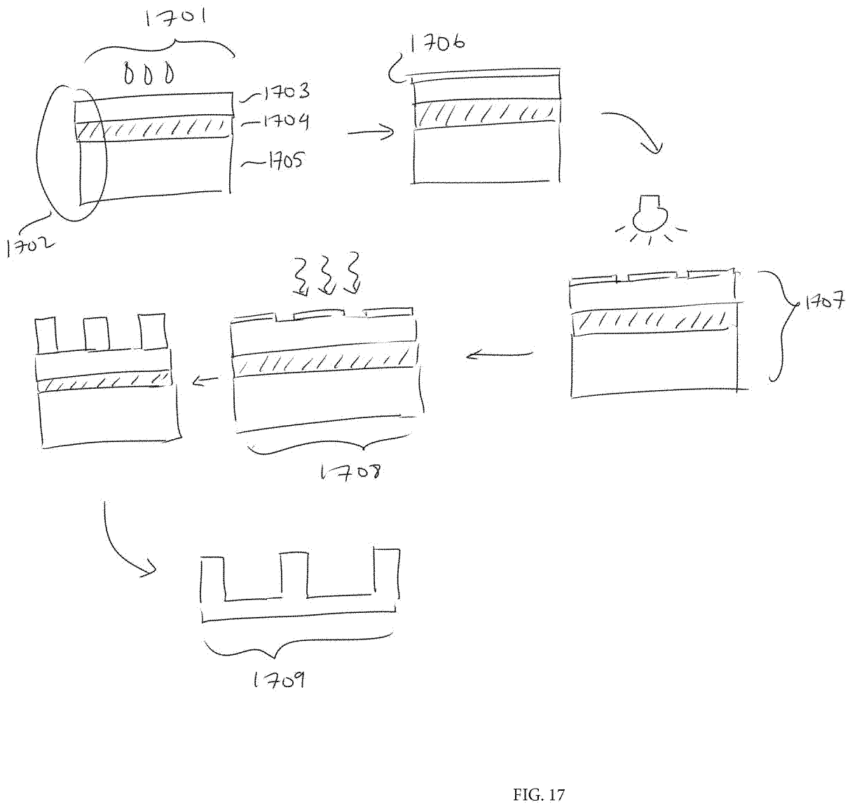

FIG. 17 depicts a way to manufacture a thin honeycomb structure with uniform thickness using a commercially available 501 (silicon-on-insulator) wafer. SOI wafers consist of a thin layer of silicon on top of an insulating layer, which in some embodiments is a thick handle wafer and in some embodiments is a thin layer of silicon dioxide on top of a handle wafer of silicon. In step 1701, the SOI wafer 1702 with silicon layer 1703, insulating layer 1704, and handle wafer 1705 is coated with photoresist 1706. In step 1707, photolithography steps on the photoresist are used to create a honeycomb structure which is subsequently etched away in step 1708 by an anisotropic etching process, for example, deep reactive ion etching (DRIE). In subsequent fabrication steps (1709) the handle wafer and insulating layer are removed by, for example but not limited to, mechanical grinding, ion etching or milling, or chemical etching to leave a thin silicon membrane which forms the structure.

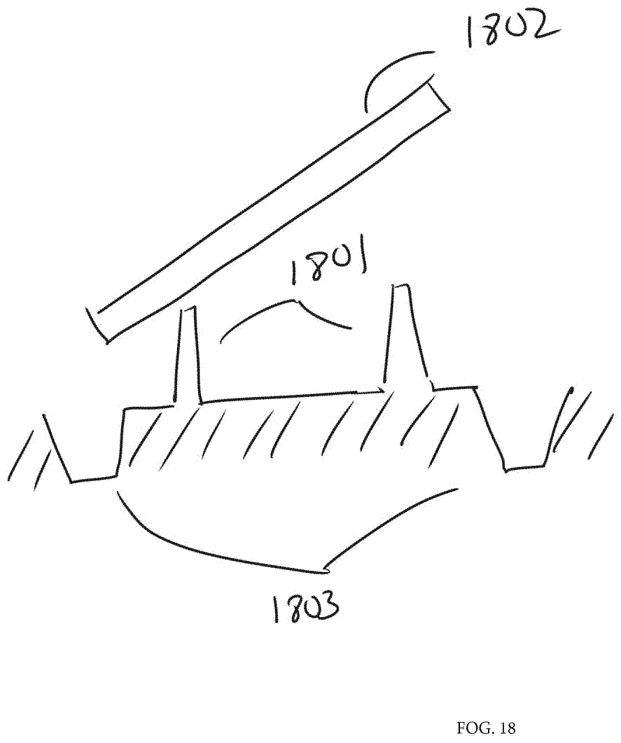

As the moving element becomes large, the reduced resonant frequency of the system makes the device more sensitive to external forces which may cause unwanted movement of the element. In extreme cases, the element may move beyond its intended range of travel, causing stress in the hinges beyond the yield stress of the hinge material and permanently damaging the device. FIG. 18 depicts a system of bump stops 1801 which catch the moving element 1802 beyond the end of its range of travel. Clearance pockets 1803 prevent the moving element from being damaged by hitting the base wafer.

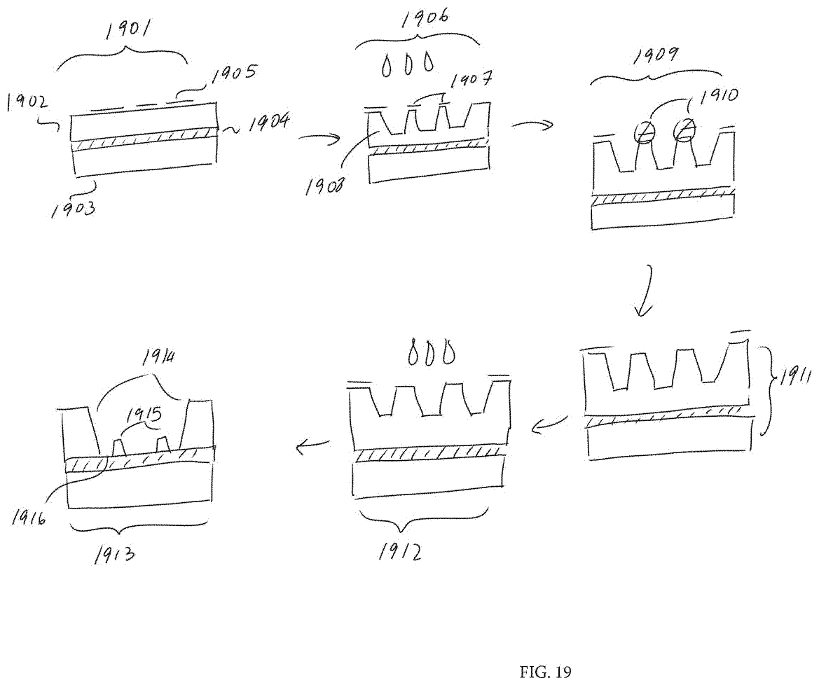

FIG. 19 depicts a modification of the process in FIG. 15 to manufacture the bump stops in FIG. 18. Step 1901 depicts an intermediate step of the manufacturing process with an electrode wafer 1902 bonded to a base wafer 1903, having an insulating layer 1904 between them and a mask 1905 which has already been patterned with a previous photolithography step and which is impervious to the action of silicon etchants. Step 1906 depicts the action of an anisotropic wet etch (for example, but not limited to, TMAH or KOH) which creates pillars 1907 and sidewalls 1908 in the electrode wafer which do not entirely penetrate through the electrode wafer. An etching step 1909 then releases the portion of the mask 1910 which is over the pillars. In some embodiments, this portion of the mask consists of a layer of silicon nitride which has been deposited in a previous step over a layer of silicon dioxide, and a isotropic etch selective for silicon dioxide, for example, but not limited to, a hydrogen fluoride wet etch, is used to remove the underlying silicon dioxide and release the silicon nitride mask from the electrode wafer. This results in the intermediate configuration 1911, which goes through another anisotropic wet etching step 1912 to create the final configuration 1913 consisting of sloped electrode sidewalls 1914, bump-stops 1915, and clearance pockets 1916.

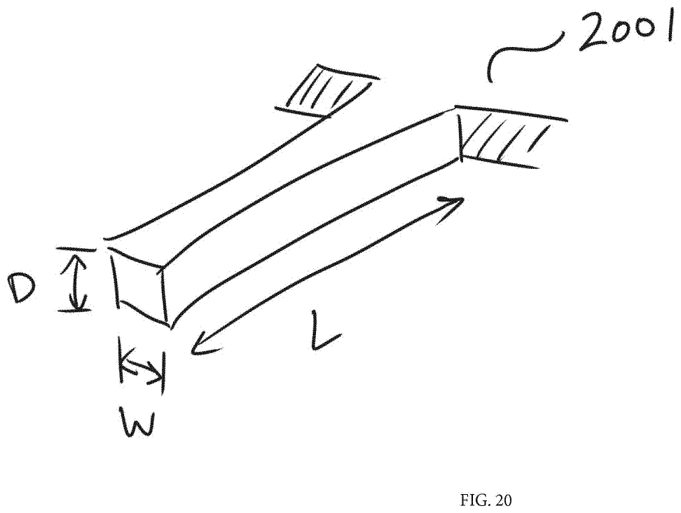

It is usually desirable to suspend the moving element on flexure hinges to eliminate the need for bearings. It is important in this case to control the stress in flexure hinges so that at maximum deflection in the hinges is significantly below the yield stress of the hinge material, for example, no more than 80% of the yield stress of the hinge material. FIG. 20 depicts the simplest form of flexure hinge, a torsion bar. As the moving element changes position, the torsion bar is twisted about its axis according to the motion.

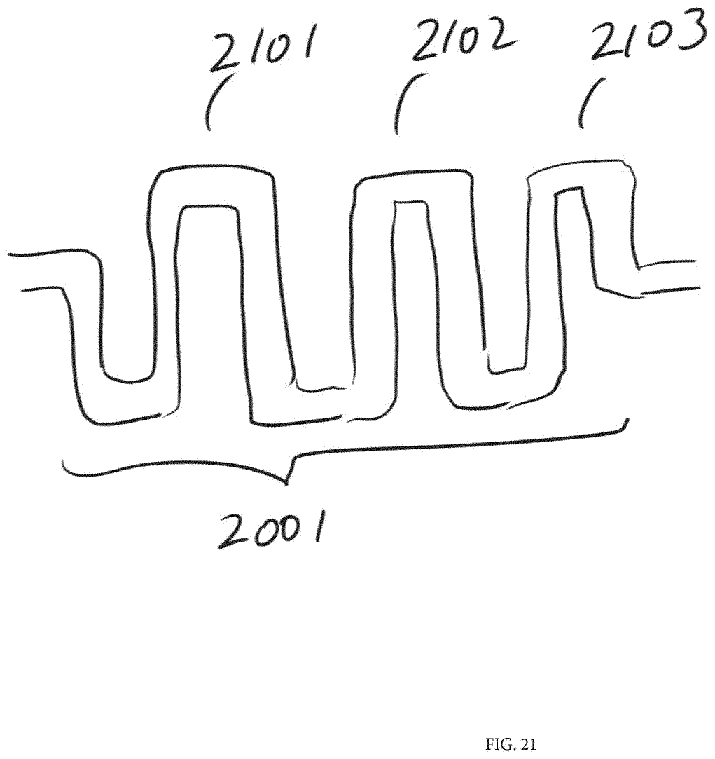

The properties of the simple torsion bar 2001 are highly dependent on the dimensions of the torsion bar in a nonlinear fashion, which makes this type of spring sensitive to manufacturing parameters. The stiffness of the torsion bar is also high for the given dimensions, which increase the stresses present and the forces required to create a required deflection. FIG. 21 depicts a refined spring hinge, the serpentine hinge, which reduces stress and reduces the spring constant of the hinge by adding repeated serpentine structures 2101, 2102, 2103 in the hinge.

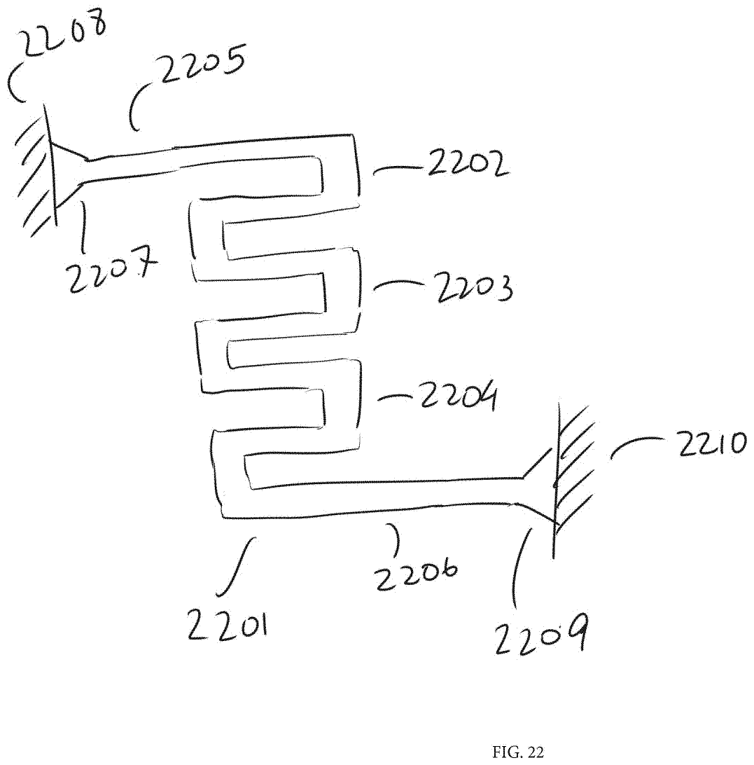

FIG. 22 depicts a further refinement of the serpentine hinge, the rotated serpentine hinge. The serpentine assembly 2201 consisting of repeated serpentine structures 2202, 2203, 2204 is suspended on arms 2205 and 2206. 2205 is anchored through the anchor structure 2207 to the moving element 2208, and 2206 is anchored through the structure 2209 to the stationary portion 2210. 2207 and 2209 are optimized to reduce local stress at the anchor, and the length, width and thickness of the horizontal serpentine segments are optimized to achieve the best resonant frequency, spring constant, and peak stress. The vertical serpentine segments can have different dimensions from the horizontal serpentine segments as needed to achieve reduced peak stress.

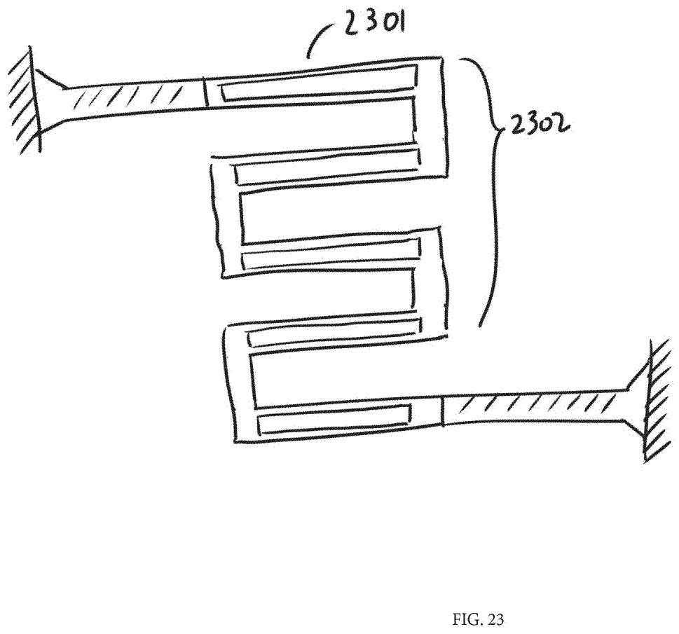

FIG. 23 depicts a further refinement of the rotated serpentine hinge, the multiple bar rotated serpentine hinge. In this structure, the horizontal arms 2301 of the serpentine section 2302 are composed of multiple thinner bars in parallel; this exemplary embodiment uses two bars but three, four, or any number of bars are possible. By optimizing the number and dimensions of these bars, an increased spring constant can be achieved without inducing excessive stress in the structures, relative to a single bar serpentine hinge

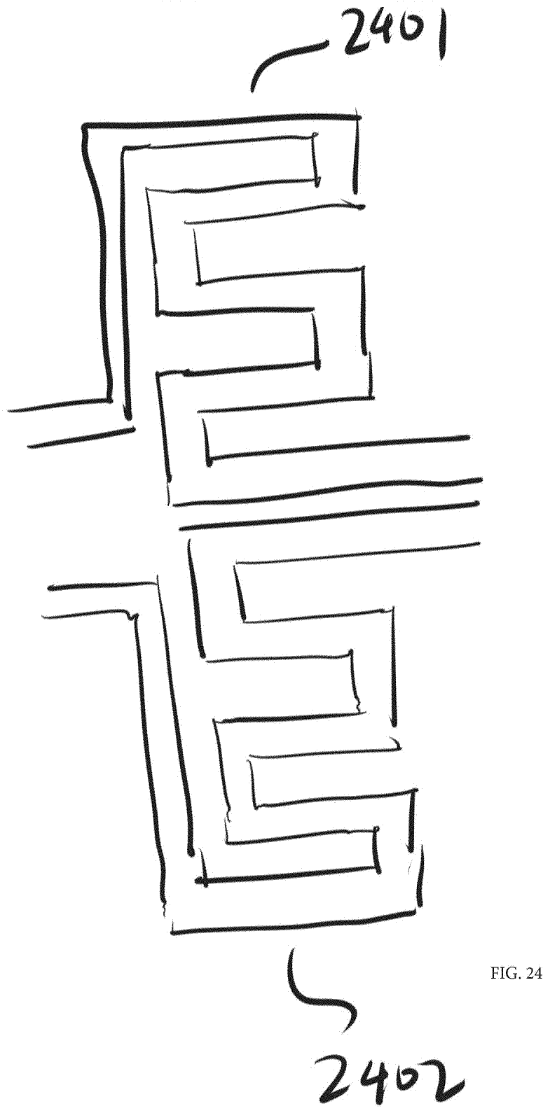

FIG. 24 depicts another hinge which can be used to increase the spring constant and reduce the peak stress, the symmetric serpentine hinge. In this structure, two oppositely-oriented rotated serpentine hinges, 2401 and 2402, are used to increase the spring constant. In some embodiments, 2401 and 2402 could be the multiple bar structure depicted in FIG. 23.

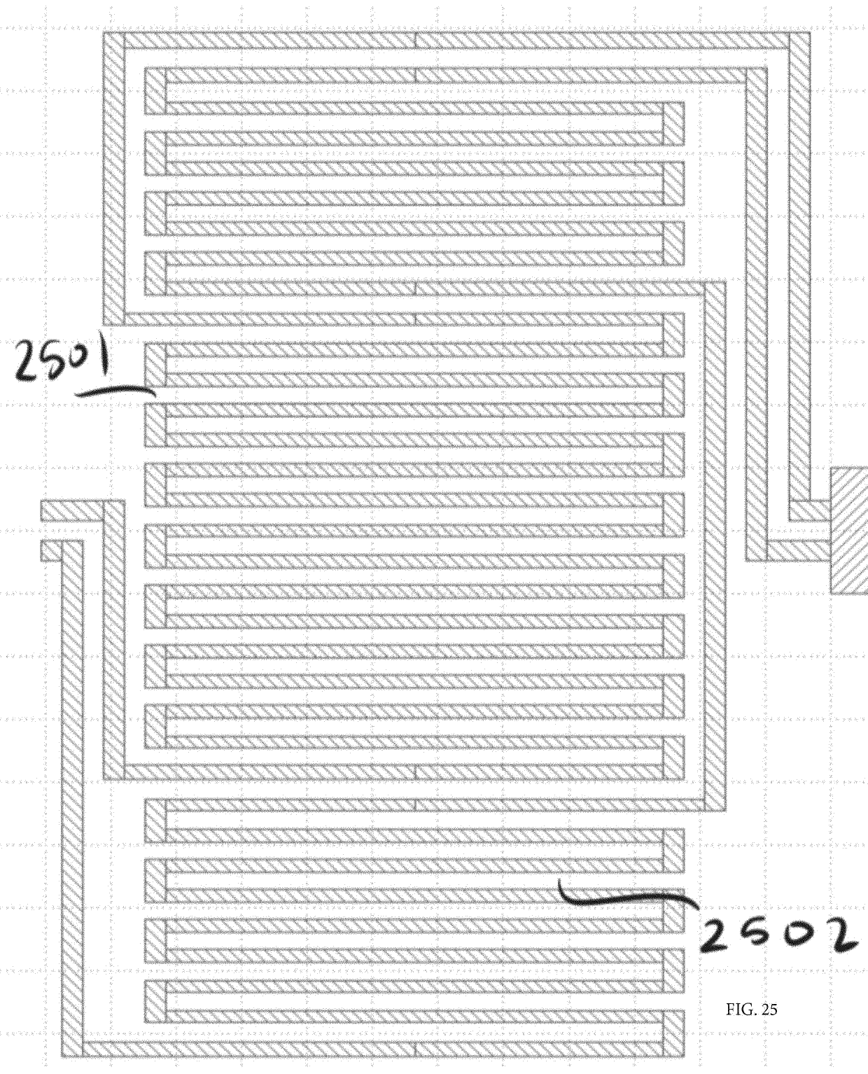

FIG. 25 depicts another hinge which can be used to increase the spring constant and reduce the peak stress, the coaxial serpentine hinge. Rotated serpentine hinge 2501 is nested within rotated serpentine hinge 2502, and the moving element is suspended on both hinges, giving an effectively higher spring constant for the combined hinge. In some embodiments, 2501 and 2502 could be the multiple bar structure depicted in FIG. 23.

In any of the hinges described herein, the dimensions of the structural elements need not be uniform throughout the extent of the hinge. These elements could vary in width or thickness throughout the hinge, and the width and thickness of each structural element could vary along its length. The exact dimensions and geometry can be determined according to the system requirements with an optimization process based on analytic approximations of the hinge behavior, or computer-aided finite-element analysis (FEA).

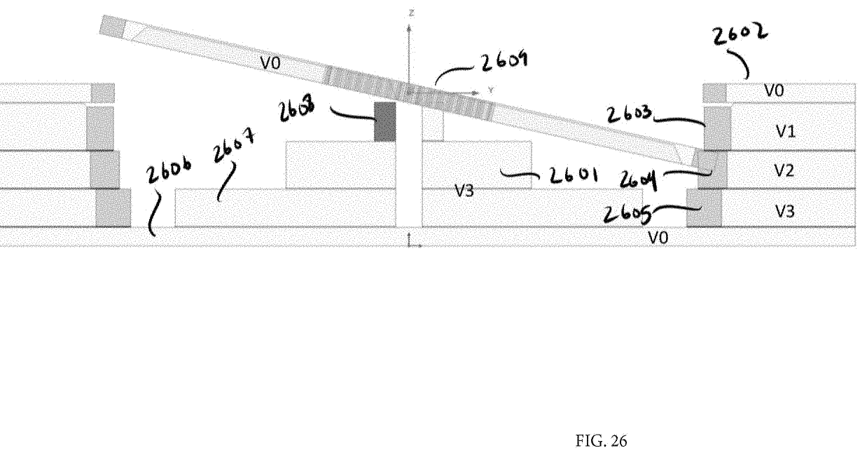

In some embodiments of the apparatus, the limitation to figure-of-merit is not the stress in the hinges, but rather the forces producible by the actuators. FIG. 26 depicts a multi-electrode actuator in which electrodes 2601˜2608 are independently controlled, electrically isolated structures which apply an electrostatic force to the moving element 2609. FIG. 26 illustrates one embodiment of the present invention in which individual electrodes are located in close proximity to the mirror at different deflection angles, thereby increasing the actuation force over the range of deflection in which the mirror rotates past at least one of the electrodes. The voltages over time for each electrode over one motion cycle of the moving element are optimized with respect to some parameters of the trajectory of the moving element, for example, but not limited to, peak acceleration, peak driving voltage, linearity, energy consumption, or cycle speed.

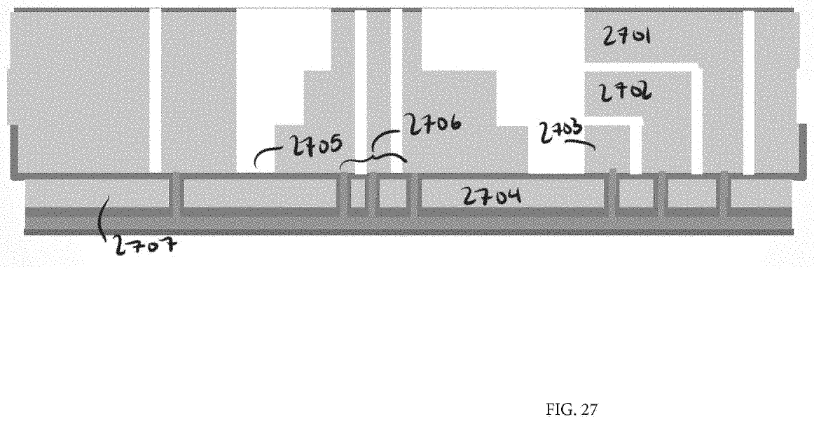

FIG. 27 depicts an embodiment of a multi-electrode actuator. The 3 electrodes 2701, 2702, and 2703 are electrically isolated from each other, and mechanically affixed through the base structure 2704. Insulator layers 2705 serve to electrically isolate the electrodes from the base layer. Vias 2706 connect the electrodes to bond pads on the bottom wafer 2707 which, through a flip chip process, are connected to terminals on the device package.

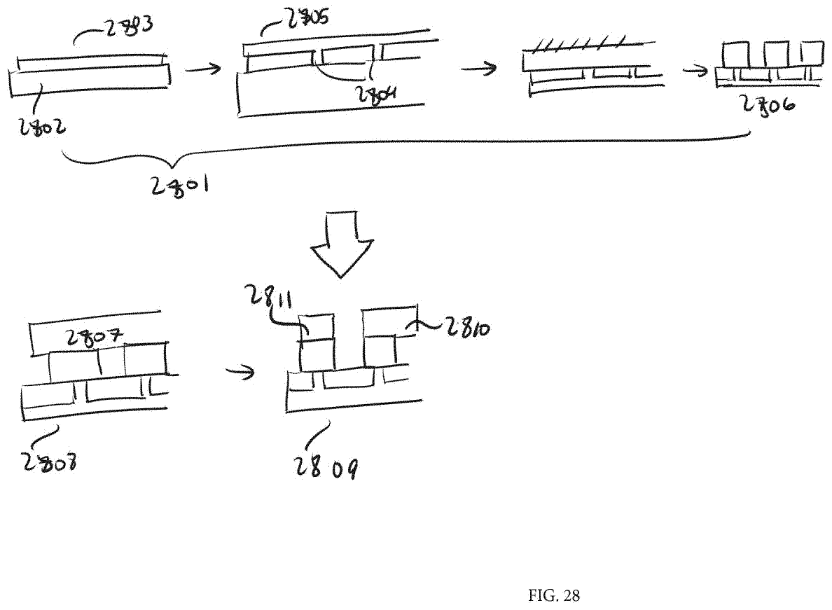

FIG. 28 depicts some key steps in a process which can be used to manufacture a multi-electrode actuator of the type exemplified by FIG. 27. In 2801, a photolithography process is used to create through-silicon vias on a bottom electrode wafer, which is a silicon-on-insulator (SOI) wafer consisting of a handle wafer 2802 and a device wafer 2803. The lithography process creates vias 2804 which are filled with a conductive material 2805, for example in-situ doped polysilicon. The wafer is then flipped, and chemical-mechanical polishing and grinding are used to thin the handle wafer. A photolithography step is used to pattern the bottom wafer electrode structure, as seen in 2806. Subsequently, to create additional electrodes, wafer 2807 can be bonded to the existing structure 2808 (the result of step 2806) using an Si—Si bonding process. Photolithography is then used to create openings in wafer 2807 to create the structure 2809, which contains completed electrodes 2810 and pillars 2811 which can support the fabrication of additional electrodes at different heights than those fabricated in previous steps.

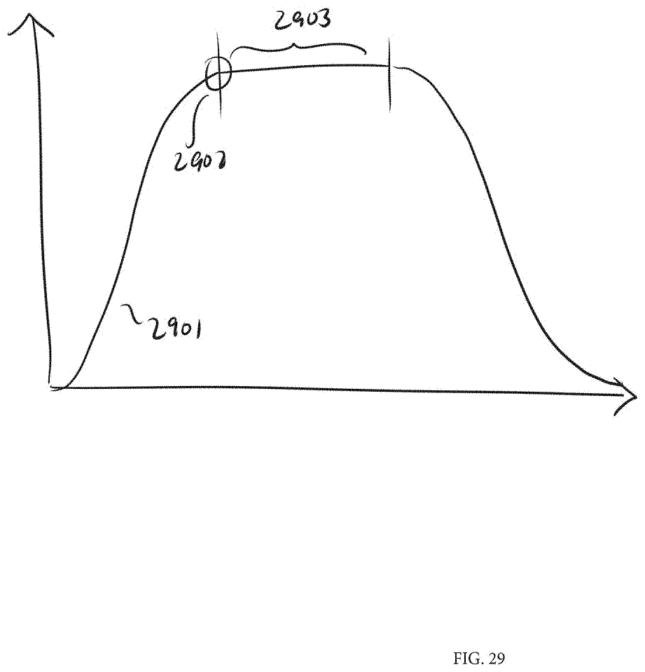

In some applications of the apparatus, the system requirements allow or demand a position trajectory of the moving element which is something other than linear or sinusoidal with respect to time. FIG. 29 depicts one such exemplary trajectory which minimizes the energy consumption of the apparatus as well as allowing several other benefits. In portion 2901 of the path of the moving element, the element moves along a sinusoidal trajectory with frequency equal to the resonant frequency of the mechanical system. At the end 2902 of this portion of the trajectory, a force is applied (while the velocity of the moving element is zero) to hold the moving element in place for a period of time 2903 which is determined by the system requirements. At the end of this period, the holding force is released, allowing the moving element reverse direction and returns to its starting position along a path 2904 which is once again sinusoidal with frequency equal to the resonant frequency of the mechanical system.

Besides reducing the energy consumption of the device, the trajectory in FIG. 29 has benefits according to its specific usage scenario. The following list is exemplary; there are other benefits not listed. In a display system, the variable hold time 2903 can be used to synchronize the motion of device with the frame output of a digital image source, for example, a computer rendering three-dimensional content with a graphics processing unit. This can be used for adaptive sync, which reduces the refresh rate of the display based on the time required to generate the images shown. It can also be used to vary the frame rate and resolution of the display based on application requirements and power limitations of the digital image source. In a stereoscopic system (which can be an imaging or display system), it can be used to precisely synchronize the refresh rates of the left and right imaging or display units. In a range finding application, for example, LIDAR, it can be used to precisely synchronize the motion of the moving element (for example, a mirror) with the emission from a light source, and to precisely synchronize multiple range finders in the same system with each other.

Another benefit of the trajectory in FIG. 29 is the ability to achieve larger deflection angles only possible with resonant excitation, while at the same time achieving a wide range of variable frame rates and/or synchronization to another display, normally not possible with resonant excitation. This benefit can be achieved by gradually exciting the mirror in resonance mode with a sinusoidal excitation until enough energy is stored within the hinge-mirror system to achieve maximum resonant deflection, and then changing to a resonate-and-hold drive method similar to that described above in order to achieve variable frame rate and/or synchronization.

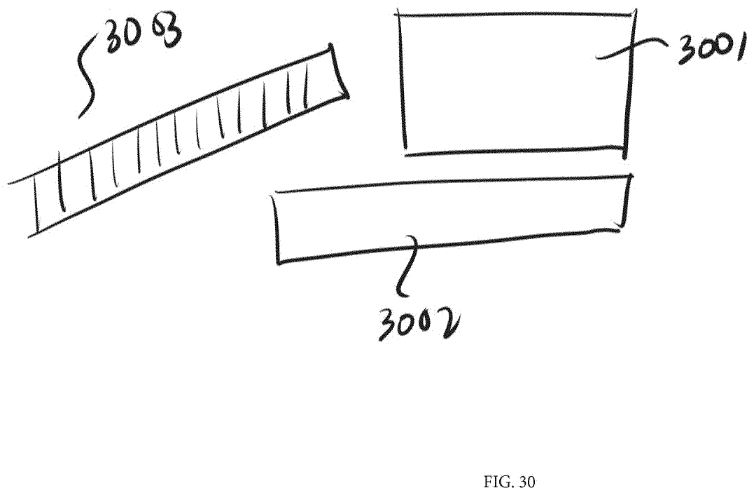

The structure of the multi-electrode actuator depicted in FIG. 26 can also be guided by the trajectory of the moving element, for example, a multi-electrode actuator could be designed to support the resonate-and-hold trajectory described above. FIG. 30 depicts an exemplary design in which two separate sets of electrodes 3001 and 3002 are used to actuate the moving element 3003. The upper electrode 3001 is optimized to generate a small force over a large distance, to enable a large range of motion for the moving element. The small electrode 3002 is optimized to generate a large force over a small distance, for example, it is a comb electrode with a small pitch and a small depth. Such a small pitch is only possible over an electrode of small depth because the aspect ratio of the process used to fabricate these combs is limited. This structure can enable the trajectory in FIG. 29, which requires a large force at the limits of travel to hold the moving element stationary at the limits of spring deflection. The electrodes 3001 and 3002 may be each more than one electrode.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A beam steering apparatus comprising:
a movable mirror;
flexure hinges configured to suspend said movable mirror;
an electrostatic actuator configured to move said movable mirror; and
wherein said movable mirror has a dimension of at least 2.5 mm in a direction perpendicular to an axis of motion and an angular range of said movable mirror is at least 30 mechanical degrees.

2. The beam steering apparatus of claim 1, wherein the electrostatic actuator contains a trench structure configured to generate a portion of the forces needed to move said movable mirror.

3. The beam steering apparatus of claim 2, further comprising:
a bonded stack of two silicon wafers; and
an insulating layer between the two silicon wafers.

4. The beam steering apparatus of claim 2, wherein said movable mirror comprises a honeycomb structure.

5. The beam steering apparatus of claim 1, further comprising:
a system of bump stops configured to prevent damage due to external forces, wherein the system of bump stops comprises pillars and sidewalls.

6. The beam steering apparatus of claim 1, where the flexure hinges comprise a rotated serpentine hinge.

7. The beam steering apparatus of claim 1, where the flexure hinges comprise a multiple bar rotated serpentine hinge.

8. The beam steering apparatus of claim 1, where the flexure hinges comprise a symmetric serpentine hinge.

9. The beam steering apparatus of claim 1, where the flexure hinges comprise a coaxial serpentine hinge.

10. The beam steering apparatus of claim 1, wherein the electrostatic actuator comprises multiple independently controllable electrodes configured to increase the force exerted by each electrode on said movable mirror as said movable mirror moves past that electrode, and further configured such that the full deflection of said movable mirror can be achieved by applying a unique sequence of voltages to two or more electrodes of the multiple independently controllable electrodes.

11. The beam steering apparatus of claim 10, wherein two or more of the multiple independently controllable electrodes are configured to optimize cycle speed.

12. A beam-steering apparatus comprising:
a movable mirror, wherein the trajectory of the movable mirror comprises of a resonant portion with a sinusoidal profile, ending when the angular velocity of the mirror is zero, followed by a stationary portion.

13. The beam-steering apparatus of claim 12, wherein the stationary portion of the trajectory is adjustable in duration according to the requirements of the application.

14. The beam-steering apparatus of claim 12, wherein the movable mirror is actuated with electrostatic actuators, and multiple independently controllable actuators are used to provide deflection forces to the movable mirror.

15. The beam-steering apparatus of claim 14, wherein electrodes at the end of the mirror's trajectory are larger than electrodes at the beginning of the movable mirror's trajectory to catch and hold the movable mirror at the end of the sinusoidal portion of its trajectory.

16. A method for fabricating the apparatus of claim 2, the method comprising the actions of:
growing an oxide or nitride layer on a silicon wafer;
bonding said silicon wafer to a second silicon wafer using a dielectric-to-silicon bond; and
using anisotropic wet etching to open a trench structure.

17. A method for fabricating the beam-steering apparatus of claim 4, wherein the movable mirror comprises a honeycomb structure, and further comprising the action of using photolithography and etching processes to create the movable mirror from a thin silicon layer of a silicon-on-insulator wafer.

18. A method for fabricating the beam-steering apparatus of claim 5, by using a photolithography and etching processes utilizing anisotropic wet etching to create pillars and sidewalls, which are then subsequently transformed into the bump stops using additional release and wet etch steps.

19. A method for designing the apparatus of claim 1, further comprising the action of using a computer optimization program or generative algorithm to optimize the parameters of the flexure hinges according to a particular figure of merit.
